(19) United States
(12) Patent Application Publication
(10) Pub. No.: US 2025/0170494 A1
(43) Pub. Date: May 29, 2025

(54) MOVEMENT STRUCTURE AND PULL-TO-SUCK-AND-LICK MASSAGE APPARATUS WITH MOVEMENT STRUCTURE

(71) Applicant: Dongguan Guigong Adult Supplies. Co., Ltd., Dongguan (CN)

(72) Inventor: Xingyu LENG, Yichun (CN)

(73) Assignee: Dongguan Guigong Adult Supplies. Co., Ltd., Dongguan (CN)

(21) Appl. No.: 18/392,288

(22) Filed: Dec. 21, 2023

(30) Foreign Application Priority Data
Nov. 28, 2023 (CN) 202311605408.7

(51) Int. Cl. A63H 13/02; A63H 29/22

(52) U.S. Cl. CPC A63H 13/02; A63H 29/22

(57) ABSTRACT

Disclosed are a movement structure and a pull-to-suck-and-lick massage apparatus with the movement structure. The movement structure includes a rotating motor, a rotating seat, and a positioning shell. The rotating motor is provided with a rotating shaft extending upwards. The rotating seat is connected to the rotating shaft. The rotating seat is provided with a driving shaft that deviates from an axis. The driving shaft extends obliquely upwards towards a direction of the axis. The positioning shell is detachably mounted at a position of an upper end of the rotating motor. The positioning shell is provided with pivot seats. The pivot seats are pivotally provided with a swinging shaft. Reciprocating pulling and gentle licking and squeezing of the tongue are realized through an elastic rod body and an elastic simulated tongue, which effectively improves the user experience of the massage apparatus.

### CROSS-REFERENCE TO RELATED APPLICATIONS

This application claims priority to Chinese Patent Application No. 202311605408.7, filed on Nov. 28, 2023, which is incorporated herein by reference in its entirety.

### TECHNICAL FIELD

The present application relates to the field of massage apparatus, and in particular, to a movement structure and a pull-to-suck-and-lick massage apparatus with the movement structure.

### BACKGROUND

In a small product (for example, a sex product), an integrated movement is often used to realize the swinging of a mechanism. However, an existing movement generally has a complex structure and a large volume, or has noise or jamming (the existing brushed motor has a running clearance during rotating).

For example, Chinese Patent Publication CN106345124A uses a combination of a drive coil and a permanent magnet. When the drive coil powered on, the swinging of a swinging arm is realized. However, this mechanism has the following disadvantages: 1, low swinging frequency: 2, small torque, that is, poor stability of a magnetic field thereof; and 3, unsuitability for batch production.

Of course, swinging movements of other structures are also used. For example, in Chinese Patent CN214436484U, in order to realize corresponding swinging, a structure that a rotating motor is matched with a sector gear is used. However, a corresponding volume is also large, the structure is complex, and meshing noise of the gear will also be produced in actual use, thereby affecting the user experience.

### SUMMARY

A main objective of the present application is to provide a movement structure, which aims to realize left and right reciprocating swinging of a toy or a component through an integrated movement, and has a simple structure and a smaller volume.

To achieve the above objective, the present application provides a movement structure, including: a rotating motor, a rotating seat, and a positioning shell.

The rotating motor is provided with a rotating shaft extending upwards.

The rotating seat is connected to the rotating shaft. The rotating seat is provided with a driving shaft that deviates from an axis. The driving shaft extends obliquely upwards towards a direction of the axis.

The positioning shell is detachably mounted at a position of an upper end of the rotating motor. The positioning shell is provided with a pivot seat. The pivot seat is pivotally provided with a swinging shaft. A driving slot that is matched with the driving shaft is arranged at a lower end of the swinging shaft. An upper end of the driving shaft is capable of sliding in a length direction of the driving slot and enables the swinging shaft to swing reciprocally. A pull-to-suck-and-lick massage apparatus includes a shell.

An elastic cup body is arranged at an upper end of the shell. The shell is provided with a swinging mechanism extending into the elastic cup body.

The swinging mechanism includes the movement structure as described above and an elastic simulated tongue arranged at an upper end of the swinging shaft.

The shell is also provided with a pull mechanism extending out of the elastic cup body. The pull mechanism includes the movement mechanism as described above and an elastic rod body arranged at the upper end of the swinging shaft.

An air suction apparatus is arranged in the shell, and the air suction apparatus is provided with an air suction hole extending into the elastic cup body.

According to the technical solution of the present application, in an actual design, the rotating motor, the rotating seat, the driving shaft, the pivot seat, and the swinging shaft are taken as parts of a movement, that is, when the rotating motor drives the rotating seat to rotate, the obliquely arranged driving shaft rotates on the periphery of the axis and the upper end of the driving shaft slides along a length direction of the driving slot, so as to drive the upper end of the driving shaft to swing reciprocally. The structure is simple, and the swinging shaft takes the pivot seat as an axis, which can reduce a swinging clearance of the swinging shaft. The swinging frequency is more linear, which effectively improves the use stability of the product, is simple in structure, and facilitates assembling. Meanwhile, the overall volume is small, which facilitating the assembling in the product.

### BRIEF DESCRIPTION OF THE DRAWINGS

FIG. 1 is an exploded view of a movement structure.

FIG. 2 is a sectional view of the movement structure.

FIG. 3 is a three-dimensional schematic diagram of the movement structure.

FIG. 4 is a schematic diagram of a rotating seat and a driving shaft.

FIG. 5 is a schematic diagram of the rotating seat and the driving shaft from another perspective.

FIG. 6 is a schematic diagram of the rotating seat.

FIG. 7 is a sectional view of a massage apparatus.

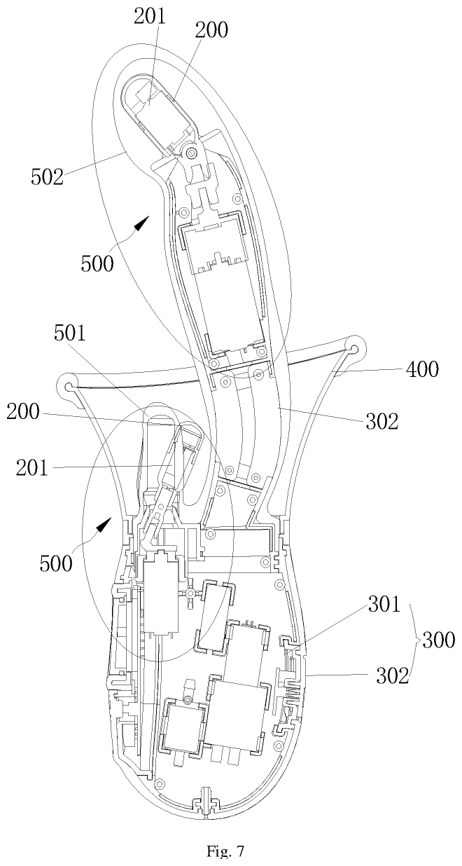

FIG. 8 is exploded view of a pulling mechanism.

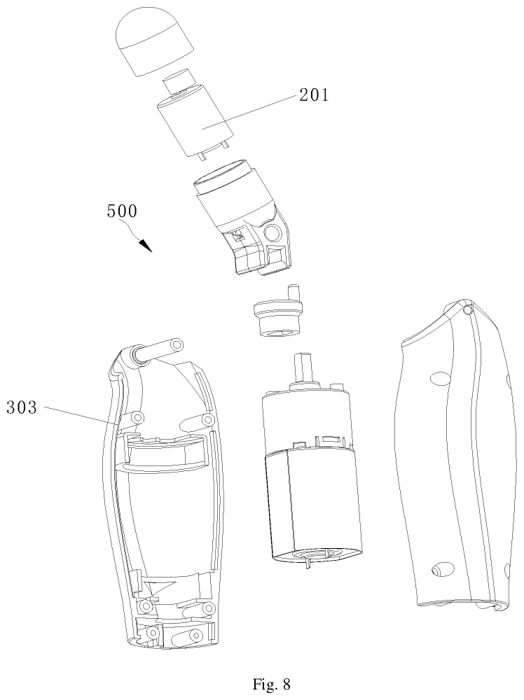

FIG. 9 is a schematic diagram of a swinging mechanism.

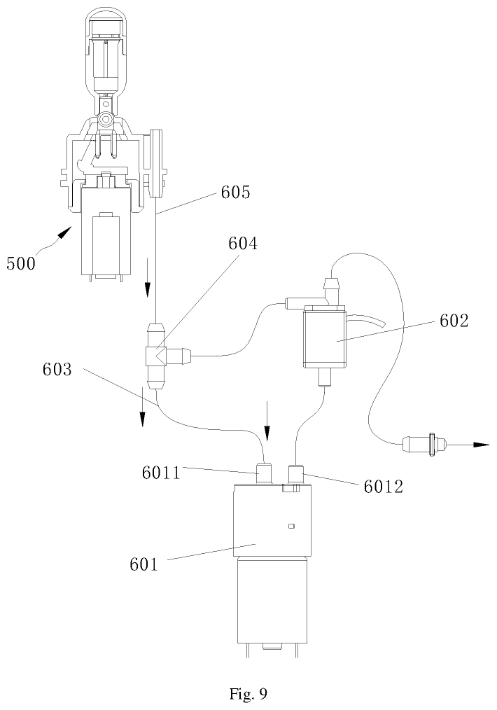

### DETAILED DESCRIPTION OF THE EMBODIMENTS

Technical solutions in embodiments of the present application will be clearly and completely described below with reference to drawings. Apparently, the described embodiments are merely part rather than all of the embodiments of the present application. Based on the embodiments of the present application, all other embodiments obtained by those of ordinary skill in the art without creative work shall fall within the scope of protection of the present application.

It is to be noted that if the embodiments of the present application involve directional indication (such as upper, lower, left, right, front, rear, top, bottom, inner, outer, vertical, transverse, longitudinal, anticlockwise, clockwise, circumferential, radial, axial . . . ), then the directional indication is only used to explain the relative position relationship, movement situations, and the like among various components under a specific attitude (as shown in the drawings). If the specific attitude changes, then the directional indication will also change accordingly.

In addition, if the embodiments of the present application involve the descriptions of “first”, “second”, and the like, the descriptions of the “first”, “second”, and the like are only for descriptive purpose, and are not understood as indicating or implicating its relative importance or implicitly indicating the number of indicated technical features. Therefore, a feature defined by “first” and “second” may explicitly or implicitly include at least one of the features. In addition, the technical solutions among various embodiments may be combined with one another, but have to be based on the realization of those of ordinary skill in the art. When the combination of the technical solutions is contradictory or cannot be realized, it is to be considered that the combination of the technical solutions does not exist and does not fall within the scope of protection required by the present application.

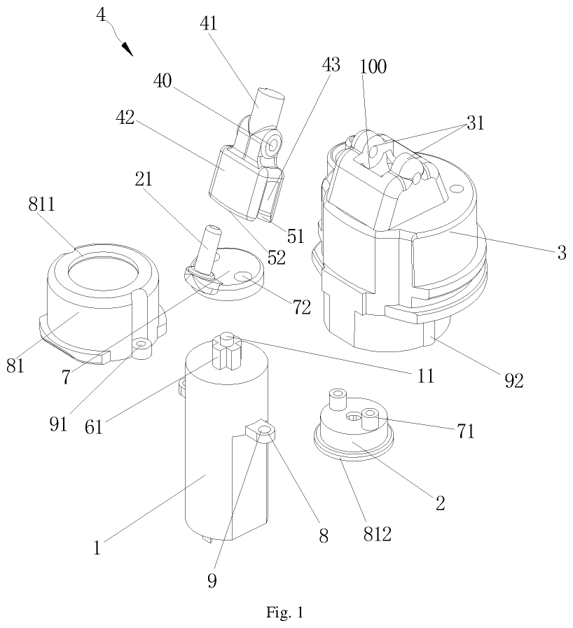

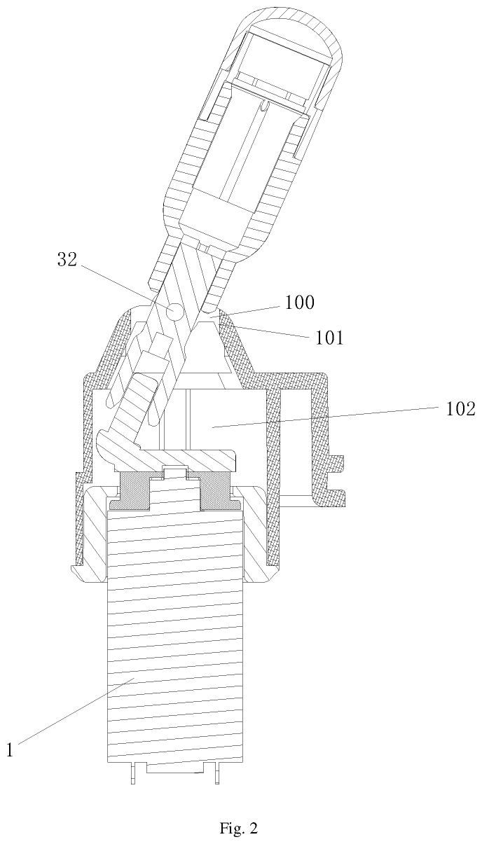

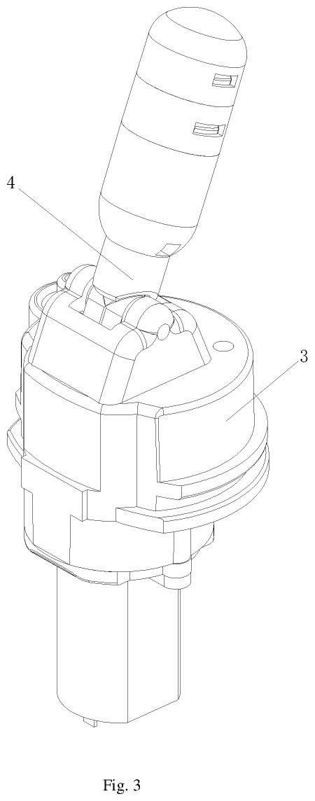

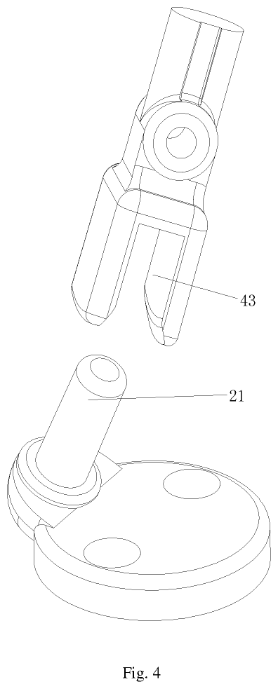

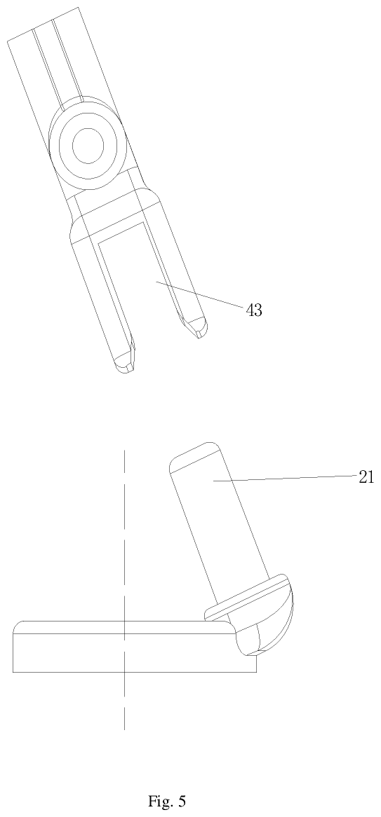

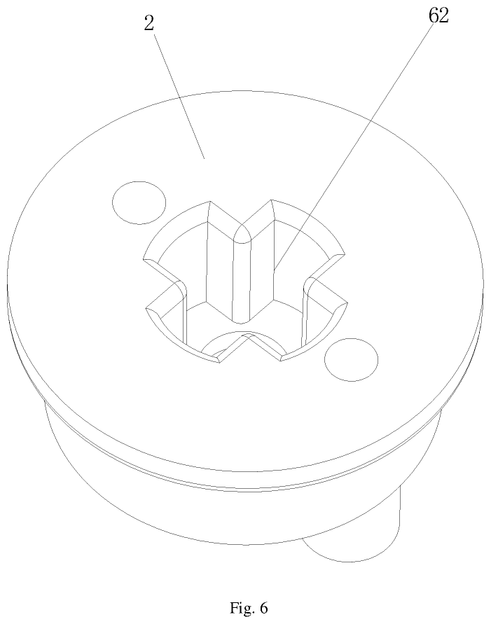

Referring to FIG. 1 to FIG. 6, a movement structure includes: a rotating motor 1, a rotating seat 2, and a positioning shell 3.

The rotating motor 1 is provided with a rotating shaft 11 extending upwards.

The rotating seat 2 is connected to the rotating shaft 11, the rotating seat 2 is provided with a driving shaft 21 that deviates from an axis, and the driving shaft 21 extends obliquely upwards towards a direction of the axis or is arranged vertically.

The positioning shell 3 is detachably mounted at a position of an upper end of the rotating motor 1. The positioning shell 3 is provided with pivot seats 31. The pivot seats 31 are pivotally provided with a swinging shaft 4. A driving slot 43 that is matched with the driving shaft 21 is arranged at a lower end of the swinging shaft 4.

In an actual design, the rotating motor 1, the rotating seat 2, the driving shaft 21, the pivot seats 31, and the swinging shaft 4 are taken as parts of a movement, that is, when the rotating motor 1 drives the rotating seat 2 to rotate, the obliquely arranged driving shaft 21 rotates on the periphery of the axis and the upper end of the driving shaft 21 slides along a length direction of the driving slot 43, so as to drive the swinging shaft 4 to swing reciprocally. The structure is simple, and the swinging shaft 4 takes the pivot seat 31 as an axis, which can reduce a swinging clearance of the swinging shaft 4. The swinging frequency is more linear, which effectively improves the use stability of the product, is simple in structure, and facilitates assembling. Meanwhile, the overall volume is small, which facilitates the assembling in the product.

Specifically, the swinging shaft 4 includes a pivot hole 40, a swinging part 41 arranged at an upper end of the pivot hole 40, and a driving part 42 arranged at a lower end of the pivot hole 40. The driving slot 43 is arranged in the driving part 42. The pivot hole 40 is connected to the pivot part through a plug shaft 32.

More specifically, a center line of the driving part 42 and a center line of the swinging part 41 are positioned at same horizontal position or arranged in a bent manner. The driving shaft 21 may slide in a width direction of the driving slot 43 and enables the swinging shaft 4 to swing by taking the pivot hole 40 as an axis, so that the overall stability of the swinging shaft 4 is higher, and a mold is easier to produce.

In the embodiments of the present application, an inclined surface 51 is formed on an inner side, positioned at a lower end of the driving slot 43, of the driving part 42; and a bottom end of the driving part 42 is an arc-shaped surface 52. The problem of jamming can be effectively avoided through the arrangement of the inclined surface 51 and the arc-shaped surface 52, so that the swinging shaft 4 rotates more stably, and the noise is lower.

Further, the rotating shaft 11 is provided with a non-circular limiting part 61. The driving shaft is provided with a limiting slot 62 that is matched with the limiting part 61. The rotating seat 2 and the driving shaft 21 are integrally formed or mounted separately. The non-circular limiting part 61 is of a plum-shaped structure, so that the rotating seat 2 is matched with the rotating shaft 11 more stably, and meanwhile, the contact area is increased, and the rotation stability is ensured.

When mounted separately, the rotating seat 2 is provided with a clamping column 71, a base 7 that fits the rotating seat 2 in shape is arranged at a bottom of the driving shaft 21. The base 7 is provided with a clamping hole 72 that is matched with the clamping column 71. The clamping column 71 is fixedly mounted through a bolt after being inserted into the clamping hole 72.

In the embodiments of the present application, a positioning part 8 is arranged on a peripheral wall of the rotating motor 1. The positioning part 8 is provided with a limiting seat 81. An upper end of the limiting seat 81 extends inwards to form a surrounding part 811. The rotating seat 2 is provided with a step part 812 that is matched with the surrounding part 811. An upper wall of the step part presses against a lower wall of the surrounding part 811, so that limiting, mounting, and fixing of the rotating seat 2 are ensured. Therefore, the rotating seat 2 serves as an individual module, thereby facilitating assembling.

Specifically, the positioning shell 3 is provided with a first screw through hole 91. The limiting seat 81 is provided with a second screw through hole 92. The positioning part 8 is provided with a screw hole 9. A screw is screwed to the screw hole 9 after penetrating through the first screw through hole and the second screw through hole in sequence, thereby facilitating the assembling of the rotating seat 2, the positioning shell, and the driving shaft 21.

More specifically, an opening is formed in an upper end of the positioning shell. Limiting surfaces 101 are formed in both ends of the opening. The pivot seats 31 are arranged on both sides of the opening, and the swinging amplitude of the swinging part 41 is limited through the size of the opening 100.

In the embodiments of the present application, the positioning shell is provided with a positioning cavity 102, and the rotating seat 2 and the driving shaft 21 are arranged in the positioning cavity, so that the whole body is more attractive, and the damage of internal components is reduced.

The driving part is provided with a hollow shell. The hollow shell 200 is provided with a vibration motor 201. The arrangement of the vibration motor further improves a user experience of the massage apparatus. An outer wall of the hollow shell is coated with a silicone shell 302.

A pull-to-suck-and-lick massage apparatus includes a shell 300.

An elastic cup body 400 is arranged at an upper end of the shell 300. The shell 300 is provided with a swinging mechanism extending into the elastic cup body 400.

The swinging mechanism includes the movement structure 500 as described above and an elastic simulated tongue 501 arranged at an upper end of the swinging shaft.

The shell 300 is also provided with a pull mechanism extending out of the elastic cup body 400. The pull mechanism includes the movement mechanism 500 as described above and an elastic rod body 502 arranged at the upper end of the swinging shaft.

An air suction apparatus 600 is arranged in the shell 300, and the air suction apparatus 600 is provided with an air suction hole extending into the elastic cup body 400.

In order to realize a better massage experience, when an elastic cup body 400 is placed at a preset massage part, an air suction apparatus 600 simulates sucking of lips by vacuum suction through an air suction hole and a fitting part. Meanwhile, reciprocating pulling and gentle licking and squeezing of the tongue are realized through the elastic rod body 502 and the elastic simulated tongue 501, which effectively improves the user experience of the massage apparatus.

Specifically, the shell 300 includes a hard inner shell 301 arranged for a swinging part mechanism and a bottom of a pull structure and an elastic silicone shell 302 that coats the hard inner shell 301. An inner wall of the elastic rod body 502 of the pull mechanism is a branch hard inner shell, and the branch hard shell is fixed to an upper end of the hard inner shell 301, so as to realize functions of pulling and licking. The hard inner shell 301 plays a role of supporting, and is arranged to mount items such as a lithium battery, and a control panel.

More specifically, the air suction apparatus 600 includes an eclectic air pump 601 provided with an air suction channel 6011 and an air exhaust channel 6012, an air suction guide pipe 602 arranged between the air suction channel and an air suction hole 605, and a solenoid valve 603 arranged at the air exhaust channel. The solenoid valve is connected to the air suction guide pipe through a tee joint 604; and the solenoid valve is also provided with an air exhaust hole. Linear control of a fluid is realized through the cooperation of the electric air pump 601 and the solenoid valve, even if the electric air pump 601 does not work, a negative pressure effective can also be achieved when the elastic cup body 400 is adsorbed to a body part, and linear air exhaust can also be realized during air exhausting, which effectively improves a user experience.

The above description is only a preferred embodiment of the present application and does not limit the scope of the patent of the present application. Any equivalent structural changes made by using the specification and drawings of the present application, or direct/indirect application to other related technical fields are included in the scope of protection of the patent of the present application under the inventive concept of the present application.

What is claimed is:

1. A movement structure, comprising:
a rotating motor, the rotating motor being provided with a rotating shaft extending upwards:
a rotating seat, the rotating seat being connected to the rotating shaft, the rotating seat being provided with a driving shaft that deviates from an axis, and the driving shaft extending obliquely upwards towards a direction of the axis; and
a positioning shell, the positioning shell being detachably mounted at a position of an upper end of the rotating motor, the positioning shell being provided with pivot seats, the pivot seats being pivotally provided with a swinging shaft, a driving slot that is matched with the driving shaft being arranged at a lower end of the swinging shaft, and an upper end of the driving shaft being capable of sliding in a length direction of the driving slot and enabling the swinging shaft to swing reciprocally.

2. The movement structure according to claim 1, wherein the swinging shaft comprises a pivot hole, a swinging part arranged at an upper end of the pivot hole, and a driving part arranged at a lower end of the pivot hole: the driving slot is arranged in the driving part: the pivot hole is connected to the pivot part through a plug shaft; and the driving shaft is capable of sliding in a width direction of the driving slot and enables the swinging shaft to swing by taking the pivot hole as an axis.

3. The movement structure according to claim 2, wherein an inclined surface is formed on an inner side, positioned at a lower end of the driving slot, of the driving part; and a bottom end of the driving part is an arc-shaped surface.

4. The movement structure according to claim 1, wherein the rotating shaft is provided with a non-circular limiting part: the driving shaft is provided with a limiting slot that is matched with the non-circular limiting part: the rotating seat and the driving shaft are integrally formed or mounted separately: when mounted separately, the rotating seat is provided with a clamping column, a base that fits the rotating seat in shape is arranged at a bottom of the driving shaft; the base is provided with a clamping hole that is matched with the clamping column; and the clamping column is inserted into the clamping hole.

5. The movement structure according to claim 4, wherein a positioning part is arranged on a peripheral wall of the rotating motor: the positioning part is provided with a limiting seat: an upper end of the limiting seat extends inwards to form a surrounding part: the rotating seat is provided with a step part that is matched with the surrounding part: an upper wall of the step part presses against a lower wall of the surrounding part: the positioning shell is provided with a first screw through hole: the limiting seat is provided with a second screw through hole: the positioning part is provided with a screw hole; and a screw is screwed to the screw hole after penetrating through the first screw through hole and the second screw through hole in sequence.

6. The movement structure according to claim 1, wherein an opening is formed in an upper end of the positioning shell; limiting surfaces are formed in both ends of the opening: the pivot seats are arranged on both sides of the opening: the positioning shell is provided with a positioning cavity; and the rotating seat and the driving shaft are arranged in the positioning cavity.

7. The movement structure according to claim 2, wherein the driving part is provided with a hollow shell; and the hollow shell is provided with a vibration motor.

8. A pull-to-suck-and-lick massage apparatus, comprising:
a shell, an elastic cup body being arranged at an upper end of the shell, and the shell being provided with a swinging mechanism extending into the elastic cup body, wherein
the swinging mechanism comprises the movement structure according to claim 1 and an elastic simulated tongue arranged at an upper end of the swinging shaft;
the shell is further provided with a pull mechanism extending out of the elastic cup body, and the pull mechanism comprises the movement structure according to claim 1 and an elastic rod body arranged at the upper end of the swinging shaft; and
an air suction apparatus is arranged in the shell, and the air suction apparatus is provided with an air suction hole extending into the elastic cup body.

9. The pull-to-suck-and-lick massage apparatus according to claim 8, wherein the shell comprises a hard inner shell arranged for a swinging part mechanism and a bottom of the pull mechanism and an elastic silicone shell that coats the hard inner shell; an inner wall of the elastic rod body of the pull mechanism is a branch hard inner shell; and the branch hard shell is fixed to an upper end of the hard inner shell.

10. The pull-to-suck-and-lick massage apparatus according to claim 8, wherein the air suction apparatus comprises an eclectic air pump provided with an air suction channel and an air exhaust channel, an air suction guide pipe arranged between the air suction channel and the air suction hole, and a solenoid valve arranged at the air exhaust channel; the solenoid valve is connected to the air suction guide pipe through a tee joint; and the solenoid valve is further provided with an air exhaust hole.
